(19) United States
(12) Patent Application Publication
(10) Pub. No.: US 2003/0079790 A1
(43) Pub. Date: May 1, 2003

(54) Flexible protective sleeve

(76) Inventors: Alan William Atkinson, Barny (GB); Alan James, Estate Bilton (GB)

Correspondence Address: Charles H Lindrooth, Synnestvedt & Lechner, Suite 2600, 1101 Market Street, Philadelphia, PA, 19107-2950, US

(21) Appl. No.: 10/149,462

(22) PCT Filed: Dec. 4, 2000
(86) PCT No.: PCT/GB00/04632

(30) Foreign Application Priority Data
Dec. 10, 1999 (GB) 99292245.0

(51) Int. Cl. F16L 11/10

(52) U.S. Cl. 138/129; 138/144

(57) ABSTRACT

A flexible protective sleeve (10; 32 to 37) comprises a supporting layer (11) formed from a strip (12) which has the general shape of a helix having a gap (14) between successive turns thereof. The sleeve (10; 32 to 37) also comprises a bridging layer (16) which is supported by said supporting layer (11) and bridges said gap (14). The bridging layer (16) is formed from flexible sheet material (18; 48) which is arranged to deform to allow said gap (14) to locally change in width to accommodate deformations of the sleeve.

This invention is concerned with a flexible protective sleeve.

Flexible protective sleeves are commonly used to protect bundles of wires and pipes in environments where abrasion, heat, corrosive materials etc may cause damage. Such sleeves are also used widely for reducing undesirable noise such as may be caused by vibration between wires or pipes and adjacent components. Such sleeves may also be used to bundle wires together for aesthetic reasons. Such sleeves are used in the engine compartments of vehicles driven by internal combustion engines. Such sleeves are usually in tubular form. Such sleeves need to be flexible enough to follow the bends in such wires or pipes. In other words, such sleeves need to be able to turn through relatively tight bends without deforming in such a way that their internal cross-section reduces, ie without kinking. This is achieved by portions of the sleeve on the inside of the bend moving towards one another while, in most cases, portions on the outside of the bend move apart.

Some conventional flexible protective sleeves are in the form of convoluted tubes made of extruded plastics. Such sleeves are, however, too stiff for some purposes. Other conventional flexible protective sleeves are made by braiding or weaving together plastics monofilaments. Such sleeves, however, have gaps between the monofilaments through which dirt, infra-red radiation, hot gases etc may pass.

It is an object of the present invention to provide an improved flexible protective sleeve which provides substantially complete coverage and has improved flexibility.

The invention provides a flexible protective sleeve having a generally tubular wall, characterised in that the wall comprises a supporting layer and a bridging layer, in that the supporting layer comprises an elongated strip which is formed into the general shape of a helix of substantially constant diameter, the helix having a gap between successive turns thereof, the strip having a substantially constant transverse cross-sectional shape with the width of the strip measured in the longitudinal direction of the helix being at least three times its maximum thickness measured radially of the helix, in that said bridging layer is formed from flexible sheet material secured to said strip and bridging said gap between the successive turns of the helix formed by said strip, and in that said sheet material is deformable to allow said gap to change in width locally to accommodate deformations of the sleeve.

In a sleeve according to the invention, the supporting layer gives the sleeve its shape and the bridging layer or, where the bridging layer does not completely cover the supporting layer, a combination of the bridging layer and the supporting layer provide substantially complete coverage for a member enclosed by the sleeve. Because the gap in said helix can change in width locally, it can accommodate bending of the sleeve, the gap increasing on the outside of bends and/or decreasing on the inside of bends, and can also accommodate longitudinal stretching or compression of the sleeve. Thus, the sleeve can be designed to have improved flexibility.

In a sleeve according to the invention, the cross-section of the strip is orientated so that the width of the strip contributes to the protection given by the strip. Preferably, the width of the strip is at least five times its maximum thickness. The strip may, for example, be generally rectangular in transverse cross-section.

In a sleeve according to the invention, said supporting layer may also comprise at least one further elongated strip positioned in said gap of said helix, said further strip also being formed into the general shape of a helix, said bridging layer also being secured to said further strip. This structure of the supporting layer could also be described as being a multi-start helix.

Where the supporting layer has only one strip, in order to improve coverage, said gap of said helix, in a fully-stretched condition of the sleeve (ie with the bridging layer taut across said gap), preferably has a width, measured longitudinally of the sleeve, which is no more than twice the width of the strip also measured longitudinally of the sleeve. More preferably, this ratio of the width of the gap to that of the strip is between 1 and 0.25 times the width of the strip. Where the supporting layer has a multi-start helix as described above, these ratios refer to the gap between adjacent coils of different strips, eg, where there are two strips, the gap between a coil of one of the strips and an adjacent coil of the other strip is preferably less than the width of either strip.

The flexible sheet material forming the bridging layer may extend tightly across said gap, when the gap has its normal width, ie when the sleeve is not deformed by being bent, stretched or compressed, so that bending of the sleeve is achieved by reducing the width of said gap on the inside of a bend. However, said flexible sheet material may extend loosely across said gap, when the gap has its normal width, so that the width of said gap can also be locally increased on the outside of a bend.

It is often desirable to provide a flexible protective sleeve with a surface which reflects infra-red radiation. Such a surface, which is usually metallic, protects the sleeve and its contents from radiant heat. However, such a surface is difficult to achieve without a smooth substrate which is not present in conventional braided or woven sleeves. Convoluted sleeves have a smooth substrate and can be given a reflective surface by vacuum aluminising but this is a slow and expensive process. In a sleeve according to the invention, this problem can be solved by arranging that the flexible sheet material forming the bridging layer comprises at least a surface layer of infrared reflective material. For example, the flexible sheet material may be a thin metal foil, or a plastics film or textile with a thin metallic layer deposited thereon. Aluminium is a suitable metal for these purposes.

In order to maximise the protection given against infra-red radiation by optimising reflectivity, as much of the sleeve as possible should present smooth surfaces to the radiation. It is, therefore, preferable, in cases where infra-red radiation is an issue, that the width of the strip forming the supporting layer is greater than the width of the gap between adjacent turns of the helix formed by the strip, when the sleeve is in a fully-stretched condition.

The bridging layer may comprise a textile or non-woven layer (eg of Tyvek—Trade Mark of Du Pont) to reinforce it and prevent tearing. This reinforcing layer can be bonded to other layers, eg to aluminium foil, or may be bonded directly to the strip forming the supporting layer.

The bridging layer may be formed from a strip of the flexible sheet material which is helically wound on to the supporting layer. The strip forming the bridging layer may cover not only the gaps between the turns of the supporting layer but also the strip forming the supporting layer. Alternatively, the bridging layer may comprise a tube formed from a strip of the flexible sheet material running parallel to the helix, the strip being wrapped on to the supporting layer by joining its opposite longitudinal edges. The flexible sheet material of the bridging layer may be fixed to the strip forming the supporting layer, eg by adhesive or welding. The bridging layer may be applied to the supporting layer when the supporting layer is in a longitudinally stretched condition, so that, on release of the sleeve, the sleeve contracts resulting in the bridging layer extending loosely across the gaps between successive turns of the helix. The bridging layer may, alternatively, be applied to the supporting layer when the supporting layer is in a longitudinally compressed condition, so that, on release of the sleeve, the sleeve expands resulting in the bridging layer extending tightly across the gaps between successive turns of the helix. In another alternative, the bridging layer may be applied to the supporting layer when the supporting layer is in a radially expanded condition, ie the strip is given a pre-set curvature which has a smaller diameter than that of said helix. Where the strip is made of thermoplastic material, this can be achieved by heat setting the strip while it is wound on a mandrel and then winding it on to a mandrel of larger diameter. It is found that, when the strip has such a pre-set curvature, cut ends of the sleeve contract reducing the gap through which infra-red radiation can pass and, where the relaxed radius of the sleeve is less than that of the wire bundle or other member being protected, the sleeve can grip the member preventing relative movement.

A sleeve according to the invention may also comprise a cushioning layer secured to the inner surface or the outer surface of said strip or positioned between the supporting layer and the bridging layer. Such a cushioning layer may comprise foam, felt or textile material and acts to cushion impacts between the sleeve and its contents or between the sleeve and nearby items, thereby reducing rattling. The cushioning layer may be provided by the bridging layer itself, eg where the bridging layer is a thin felt.

A sleeve according to the invention may also comprise a further bridging layer, one bridging layer being secured to the outer surface of said strip and the other being secured to the inner surface of said strip.

The invention also provides a method of manufacturing a flexible protective sleeve having a generally tubular wall, characterised in that the method comprises forming a supporting layer of said wall by forming an elongated strip which has substantially constant transverse cross-sectional shape into the general shape of a helix of substantially constant diameter, so that the helix has a gap between successive turns thereof, and the width of the strip measured in the longitudinal direction of the helix is at least three times its maximum thickness measured radially of the helix, the method also comprising forming a bridging layer of said wall from flexible sheet material secured to said strip so that said bridging layer bridges said gap between the successive turns of the helix formed by said strip, and said sheet material is deformable to allow said gap to change in width locally to accommodate deformations of the sleeve.

In a method according to the invention said helix may be in a longitudinally stretched condition, or in a longitudinally compressed condition, or in a radially expanded condition, when said flexible sheet material is secured thereto.

There now follow detailed descriptions, to be read with reference to the accompanying drawings, of illustrative flexible protective sleeves according to the invention, and of an illustrative method of manufacturing a flexible protective sleeve.

In the drawings:

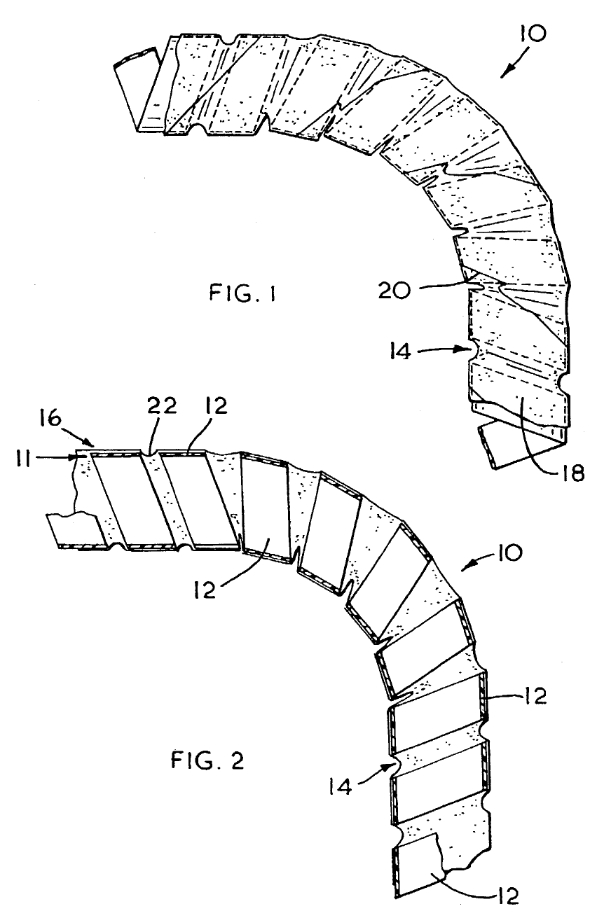

FIG. 1 is a side elevational view of a portion of a first illustrative sleeve, showing it in a bent condition;

FIG. 2 is a longitudinal cross-sectional view taken through the portion of the first illustrative sleeve which is shown in FIG. 1;

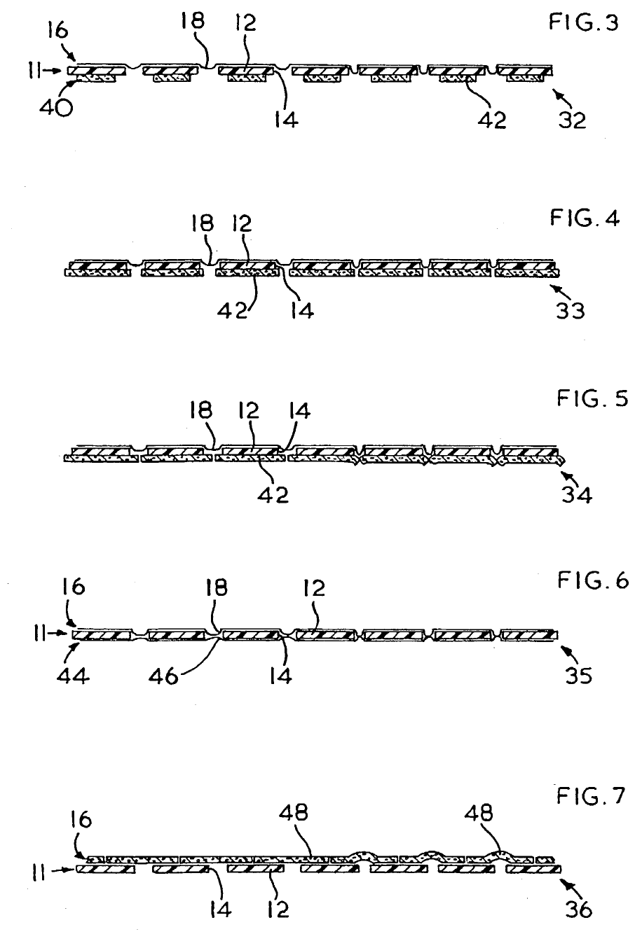

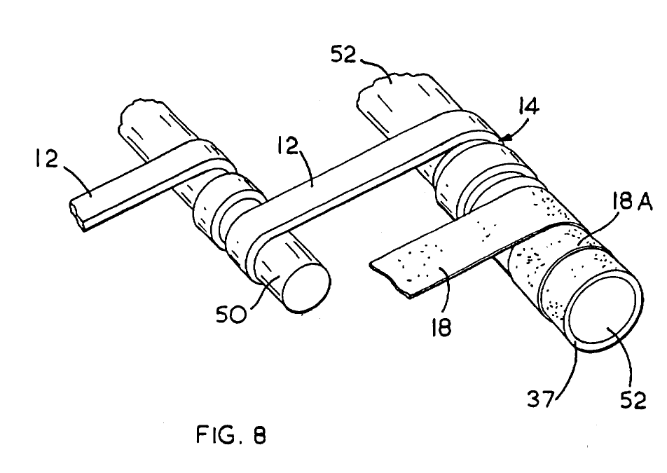

FIGS. 3 to 7 are, respectively, longitudinal cross-sectional views taken through portions of a second to a sixth illustrative sleeve, the left-hand side of the figures, in each case, showing a normal condition of the sleeve and the right-hand side showing a longitudinally compressed condition thereof; and

FIG. 8 is a diagrammatic view of the manufacture of a seventh illustrative sleeve by the illustrative method.

The first illustrative sleeve 10 (FIGS. 1 and 2) is a flexible protective sleeve having a generally tubular wall. The sleeve 10 has an internal diameter of 15 mm and is for use in protecting a bundle of wires in the engine compartment of a vehicle. The wall of the sleeve 10 comprises a supporting layer 11 which comprises an elongated strip 12 made of polyester (polypropylene is another possibility). The strip 12 has a rectangular transverse cross-sectional shape which is substantially constant along the length of the strip. The strip 12 has a width of 10 mm and a thickness of 0.5 mm.

The strip 12 is formed into the general shape of a helix of substantially constant diameter. The helix has a gap 14 between successive turns thereof. The strip 12 is orientated in the helix with its thickness extending radially of the helix. Thus, the strip 12 has a substantially constant width measured in the longitudinal direction of the helix which, because of the winding angle of the helix, is greater than 10 mm. The strip 12 also has a substantially constant thickness in the radial direction of the helix of 0.5 mm. In modifications of the sleeve 10, the strip 12 may have other transverse cross-sections but, in order to ensure that the strip provides good protection, the width of the strip 12 measured in the longitudinal direction of the helix should be at least 3 times its maximum thickness measured radially of the helix, preferably at least 5 times or even 20 times. The gap 14 is normally 5 mm wide. The term “normally” is used herein to mean a condition of the sleeve 10 in which it is neither bent nor stretched nor compressed.

The helix formed by the strip 12 has a winding angle of approximately 20 degrees and a substantially constant diameter along its length. Normally, the longitudinal axis of the helix is straight, although bends could be moulded or heat-set into it, if required. In the helix, the strip 12 is orientated so that the major surfaces of the strip 12 face radially inwardly and outwardly of the helix. The material forming the strip 12 and the dimensions of the strip are selected to be such that the strip is self-supporting in its helical form.

The sleeve 10 also comprises a bridging layer 16 which is supported by said supporting layer 11 and bridges said gap 14 between the successive coils of said strip 12. The bridging layer 16 is formed from flexible sheet material in the form of a strip 18 of polyester film with a thin surface layer (less than 1 micron in thickness) of infra-red radiation reflecting metal, specifically aluminium, deposited thereon. The metal layer faces outwardly of the sleeve 10, although it may face inwardly or there may be two such layers, one facing inwardly and the other outwardly. The strip 18 is 25 mm wide and 10 microns thick. The strip 18 is helically wound on to the helix formed by the strip 12 forming a complete tube which bridges the gap 14. The strip 18 has a winding angle of approximately 45 degrees so that overlapping joints 20 (not shown in FIG. 2) are formed, although the winding angle of the strip 18 could be the same as that of the strip 12. The strip 18 is held in position by adhesive which secures it to the outer surface of the strip 12 or to overlapping and/or underlying portions of itself. The layer 16 extends tightly over the strip 12 and the outline of the strip 12 below the strip 18 is visible in FIG. 1. At the gap 14, in the normal condition of the sleeve 10, the layer 16 is loose, ie the layer 16 has a fold 22 therein extending along said gap. This is achieved by helically winding the strip 18 on to the helix formed by the strip 12 when the helix is stretched into an elongated state. The fold 22 enables the layer 16 to deform by flexing to allow said gap 14 to locally change in width to accommodate bending of the sleeve 10 or longitudinal compression or stretching thereof.

FIGS. 1 and 2 illustrate how the sleeve 10 bends without kinking. The fold 22 opens out on the outside of the bend and closes on the inside of the bend.

The second to seventh illustrative sleeves 32 to 37, shown in FIGS. 3 to 8, respectively, are all similar to the first illustrative sleeve 10 and like parts are given the same reference numerals herein. Each sleeve 32 to 36 comprises a supporting layer 11 formed from a strip 12 formed into the general shape of a helix, and a bridging layer 16 bridging the gap 14 between successive turns of the helix, the bridging layer 16 being formed from flexible sheet material 18.

The second illustrative sleeve 32 differs from the first illustrative sleeve 10 in that it also comprises a cushioning layer 40 secured to the inner surface of the strip 12 in order to cushion impacts between the contents of the sleeve 32 and the strip 12. The layer 40 is formed by an elongated strip 42 of foam (felt or three-dimensional textiles are other possibilities). The strip 42 is narrower than the strip 12 and is adhered to the strip 12 centrally thereof so that the strip 42 follows the helix formed by the strip 12.

The third illustrative sleeve 33 differs from the second illustrative sleeve 32 in that the strip 42 of foam is slightly wider than the strip 12 and makes a contribution to sealing the gap 14. In the fourth illustrative sleeve 34 which is otherwise similar to the sleeve 33, the strip 42 is even wider and, in the normal condition of the sleeve 34, substantially bridges the gap 14. In the sleeve 34, the strip 42 has to flex to allow the gap 14 to narrow.

The fifth illustrative sleeve 35 differs from the first illustrative sleeve 10 in that it also comprises a further bridging layer 44 which is similar to the layer 16 but is secured to the inner surface of the strip 12. The layer 44 is formed by a strip 46 of flexible sheet material which is similar to the material 18. The strip 46 may have infra-red reflecting surface layers facing inwardly or outwardly of the sleeve 35 or both.

The sixth illustrative sleeve 36 differs from the first illustrative sleeve 10 in that its bridging layer 16 is formed from an elongated strip 48 of flexible sheet material formed into an edge-abutting helix with the abutments between successive turns of the helix positioned so that they do not coincide with the gap 14. The strip 48 is formed of cushioning material similar to that forming the strip 42. The strip 48 is secured along its longitudinal edges to the strip 12 with the centre of the strip 48 spanning the gap 14. In the normal condition of the sleeve 36, the strip 48 extends tightly across the gap 14 but can flex to allow the gap 14 to narrow.

FIG. 8 illustrates a method, according to the invention, of manufacturing a seventh illustrative flexible protective sleeve 37. The sleeve 37 differs from the sleeve 10 in that the winding angle of the strip 18 is the same as that of the strip 12, in that the strip 18 is tight across the gap 14, in that the strip 18 forms overlapping joints 18a, and in that the strip 12 has a pre-set curvature which has a smaller diameter than the helix of the supporting layer 11.

In the illustrative method, the strip 12 is first heated to a temperature sufficient to make it pliable and is wound on to a mandrel 50, thereby forming a helix with a constant internal diameter approximately equal to the external diameter of the mandrel 50. While on the mandrel 50, the strip 12 is cooled so that it sets itself into a helix. The strip 12 is straightened to remove it from the mandrel 50 but retains the pre-set curvature to which it returns when not forced out of that curvature. The strip 12 is then fed to a mandrel 52 of larger diameter than the mandrel 50.

In the illustrative method, the strip 12, with its pre-set curvature, is formed into the supporting layer 11 of the wall of the sleeve 37 by forming it into the general shape of a helix of substantially constant diameter by winding it on to the mandrel 52. The helix has a gap 14 between successive turns thereof, and the width of the strip 12 measured in the longitudinal direction of the helix is at least three times its maximum thickness measured radially of the helix. The method also comprises forming a bridging layer 16 of the wall of the sleeve 37 from flexible sheet material secured to said strip 12 so that said bridging layer 16 bridges said gap 14. The bridging layer 16 is formed by winding the strip 18 on to the mandrel 52 on top of the strip 12 and securing it to the strip 12 and its with adhesive. Thus, said helix is in a radially expanded condition when said flexible sheet material 18 is secured thereto, since it is on the mandrel 52. The material 18 holds the helix in its expanded condition.

1. A flexible protective sleeve (10; 32 to 37) having a generally tubular wall, characterised in that the wall comprises a supporting layer (11) and a bridging layer (16), in that the supporting layer (11) comprises an elongated strip (12) which is formed into the general shape of a helix of substantially constant diameter, the helix having a gap (14) between successive turns thereof, the strip (12) having a substantially constant transverse cross-sectional shape with the width of the strip measured in the longitudinal direction of the helix being at least three times its maximum thickness measured radially of the helix, in that said bridging layer (16) is formed from flexible sheet material (18; 48) secured to said strip (12) and bridging said gap (14) between the successive turns of the helix formed by said strip, and in that said sheet material (18; 48) is deformable to allow said gap (14) to change in width locally to accommodate deformations of the sleeve.

2. A sleeve according to claim 1, characterised in that said strip (12) is generally rectangular in transverse cross-section.

3. A sleeve according to either one of claims 1 and 2, characterised in that said supporting layer (11) also comprises at least one further elongated strip (12) positioned in said gap (14) of said helix, said further strip also being formed into the general shape of a helix, said bridging layer (16) also being secured to said further strip.

4. A sleeve according to any one of claims 1 to 3, characterised in that said gap (14) between adjacent coils of the strip or strips (12) of said supporting layer (11), in a fully-stretched condition of the sleeve, has a width, measured longitudinally of the sleeve, which is no more than the width of said strip or strips, also measured longitudinally of the sleeve.

5. A sleeve according to any one of claims 1 to 4, characterised in that the flexible sheet material (18; 48) forming said bridging layer (16) extends loosely across said gap (14) when said gap has its normal width.

6. A sleeve according to any one of claims 1 to 4, characterised in that the flexible sheet material (18; 48) forming said bridging layer (16) extends tightly across said gap (14) when said gap has its normal width.

7. A sleeve according to any one of claims 1 to 6, characterised in that the flexible sheet material (18; 48) comprises at least a surface layer of infra-red radiation reflective material.

8. A sleeve according to any one of claims 1 to 7, characterised in that said bridging layer (16) is formed from a strip of the flexible sheet material (18; 48) which is helically wound on to the supporting layer (11).

9. A sleeve according to any one of claims 1 to 7, characterised in that the bridging layer (16) comprises a tube formed from a strip of the flexible sheet material (18; 48) running parallel to the helix, the strip being wrapped on to the supporting layer (11).

10. A sleeve according to any one of claims 1 to 9, characterised in that said strip (12) has a pre-set curvature which has a smaller diameter than that of said helix.

11. A sleeve according to any one of claims 1 to 9, characterised in that said strip (12) has a pre-set curvature which has the same diameter as that of said helix.

12. A sleeve according to any one of claims 1 to 11, characterised in that the sleeve also comprises a cushioning layer (40) secured to the inner surface or the outer surface of said strip (12).

13. A sleeve according to claim 12, characterised in that the cushioning layer (40) is between the supporting layer (11) and the bridging layer (16).

14. A sleeve according to any one of claims 1 to 13, characterised in that the sleeve also comprises a further bridging layer (44), one bridging layer being secured to the outer surface of said strip (12) and the other being secured to the inner surface of said strip.

15. A method of manufacturing a flexible protective sleeve (10; 32 to 37) having a generally tubular wall, characterised in that the method comprises forming a supporting layer (11) of said wall by forming an elongated strip (12) which has substantially constant transverse cross-sectional shape into the general shape of a helix of substantially constant diameter, so that the helix has a gap (14) between successive turns thereof, and the width of the strip measured in the longitudinal direction of the helix is at least three times its maximum thickness measured radially of the helix, the method also comprising forming a bridging layer (16) of said wall from flexible sheet material (18; 48) secured to said strip (12) so that said bridging layer bridges said gap (14) between the successive turns of the helix formed by said strip, and said sheet material is deformable to allow said gap to change in width locally to accommodate deformations of the sleeve.

16. A method according to claim 15, characterised in that said helix is in a longitudinally stretched condition when said flexible sheet material (18; 48) is secured thereto.

17. A method according to claim 15, characterised in that said helix is in a longitudinally compressed condition when said flexible sheet material (18; 48) is secured thereto.

18. A method according to any one of claims 15 to 17, characterised in that said helix is in a radially expanded condition when said flexible sheet material (18; 48) is secured thereto.
